(19) United States
(12) Patent Application Publication
(10) Pub. No.: US 2021/0410094 A1
(43) Pub. Date: Dec. 30, 2021

(54) DETERMINING TIMING DIFFERENCES BETWEEN PRIMARY AND SECONDARY COMPONENT CARRIERS HAVING VARIABLE TRANSMISSION TIME INTERVALS

(71) Applicant: Apple Inc., Cupertino, CA (US)

(72) Inventors: Jie Cui, Santa Clara, CA (US); Hong He, Sunnyvale, CA (US); Yang Tang, Pleasanton, CA (US); Yuan Zhu, Beijing (CN); Shuang Tian, Santa Clara, CA (US)

(21) Appl. No.: 16/476,397

(22) PCT Filed: Feb. 6, 2018
(86) PCT No.: PCT/US18/17055

§ 371 Date: Jul. 8, 2019

Related U.S. Application Data
(60) Provisional application No. 62/455,475, filed on Feb. 6, 2017.
(60) Provisional application No. 62/456,019, filed on Feb. 7, 2017.

(51) Int. Cl. H04W 56/00; H04W 52/24

(52) U.S. Cl. CPC H04W 56/0055; H04W 52/24

(57) ABSTRACT

Methods and architectures to determine whether carrier aggregation (CA) component carrier signals transmitted or received by a user equipment (UE) device with a primary serving cell (PCell) and one or more secondary serving cells (SCell) exceed a maximum transmission timing difference compare a relative difference of signals derived from subframe boundaries, a subslot transmission time interval (sTTI) boundary or a combination thereof, with a maximum receive timing threshold value. In the uplink, timing advance groups (TAGs) for the PCell and/SCells may be compared by the UE to a maximum transmit timing threshold value. If the maximum thresholds are exceeded, the SCell may be dropped or changed to avoid UE from exceeding its power maximums.

### CROSS-REFERENCE TO RELATED APPLICATIONS

This application claims benefit of priority under 35 U.S.C. 119(e) to co-pending U.S. Applications Ser. No. 62/455,475 and 62/456,019, titled: Method and/or Apparatus of or for Timing Difference Between Primary Cell and Secondary Cell for Shortened Transition/Transmission Time Interval, filed Feb. 6, 2017 and Feb. 7, 2017 respectively, by the same inventors as the subject application, and are incorporated herein by their reference.

### BACKGROUND

Embodiments of the present invention relate generally to wireless communications, and more particularly, but not limited to, new types of communication formats and protocols for use in next generation wireless networks.

Ongoing efforts to develop next generation wireless networks, such as 3GPP LTE, have resulted in an ever increasing complexity of solutions to support capacity of the growing number of worldwide users, data demands and usage models.

LTE-Advanced (LTE-A), i.e., Release 10 and higher (for R13/14, referred to as “LTE-A Pro”), the use of Carrier Aggregation (CA) was defined and has evolved. CA is a straightforward way to increase wireless capacity by adding more bandwidth, maintaining backward compatibility with LTE Release 8 (R8) and Release 9 (R9) protocols, by aggregating UL and/or DL carrier signals, individually called a “component carriers (CC) between UEs and primary and secondary serving cells in both frequency division duplexing (FDD) and time division duplexing (TDD) modes of LTE operation. Another advancement in LTE Rel. 15, is the ability to scale the transmission time interval (TTI) of UL/DL LTE radio frames between the legacy 1 ms subframe length TTI, and lessor duration TTIs or “shortened” or “subslot” TTIs (sTTIs), in which to send data in transport or resource blocks of subframes. Combining these improvements in an efficient, workable and backward compatible manner is challenging and requires further advancements. Specifically, a precise manner of determining timing for a CA-enabled UE to properly handle different CCs having a potential variety of different TTI durations is needed.

### BRIEF DESCRIPTION OF THE DRAWINGS

Certain circuits, logic operation, apparatuses and/or methods will be described by way of non-limiting example only, in reference to the appended Drawing Figures in which:

FIG. 1 shows a simplified block diagram of a wireless network using carrier aggregation in heterogeneous network according to various embodiments of the invention;

FIG. 2 shows a timing diagram of uplink subframes of a primary component carrier and secondary component carrier having differing duration transmission timing intervals and timing issues resulting from 3GPP vague definitions, according to various aspects;

FIGS. 3A and 3B show example diagrams of CA component carriers having timing differences which result in overlapping TTIs/sTTIs at a UE which cause potential power control issues, certain embodiments of the invention may overcome;

FIG. 4 shows a timing diagram of carrier aggregation with variable transmission time intervals of a PCell carriers and SCell carriers and a UE determining timing differences based on subframe timing boundaries according to certain example embodiments of the invention;

FIG. 5 shows a timing diagram of transmission subframes of a primary component carrier and secondary component carrier and UE determining timing differences based on TTI timing boundaries according to other embodiments of the invention;

FIG. 6 is a functional block diagram detailing a method for determining timing differences of downlink transmissions using CA signals having variable TTI durations and determining time differences of uplink transmissions between component carriers to determine if they meet or exceed a maximum transmission timing difference (MTTD) in both uplink and downlink requirements; and

FIG. 7 shows an example block diagram of a wireless device such as user equipment (UE) adapted to perform certain functions and features of various embodiments of the disclosure.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the aspects of the various embodiments may be practiced in other examples that depart from the specific details discussed herein. In certain instances, descriptions of well-known devices, circuits, and methods are omitted so as not to obscure the description of the various embodiments with unnecessary detail.

In LTE-A carrier aggregation (CA), each aggregated carrier is referred to as a component carrier (CC), and by way of example, each CC may have a bandwidth of 1.4, 3, 5, 10, 15 or 20 MHz, with a maximum bandwidth of 100 MHz for five aggregated component carriers. The number of aggregated CCs can be vary in the downlink (DL) and in the uplink (UL), however, in 3GPP LTE-A, the number of UL component carriers is never larger than the number of DL component carriers and individual CCs can also have different bandwidths. A specified number of carrier aggregation configurations are available, e.g. based on combinations of E-UTRA operating band and the number of component carriers. For example, in LTE Release 10 (R10), there are two component carriers in the DL and only one in the UL (i.e., no carrier aggregation available in the UL). In R11 two component carriers in the DL and one or two component carriers in the UL were defined. In R12-R15, several more CCs configurations were made available, and CA configurations continue to increase as the standard evolves, and the embodiments of the present invention are not limited to any specific number, type or combination of CCs, serving cells, etc.

The simplest way to schedule resources using carrier aggregation is to use contiguous component carriers within the same operating frequency band (as defined for LTE), referred to as intra-band contiguous CA, which is not always be possible due to varying frequency allocation, interference and cell-edge scenarios. For non-contiguous allocations CA may use either intra-band, i.e. the component carriers belong to the same operating frequency band, but are separated by a frequency gap, or inter-band, in which case the component carriers belong to different operating frequency bands.

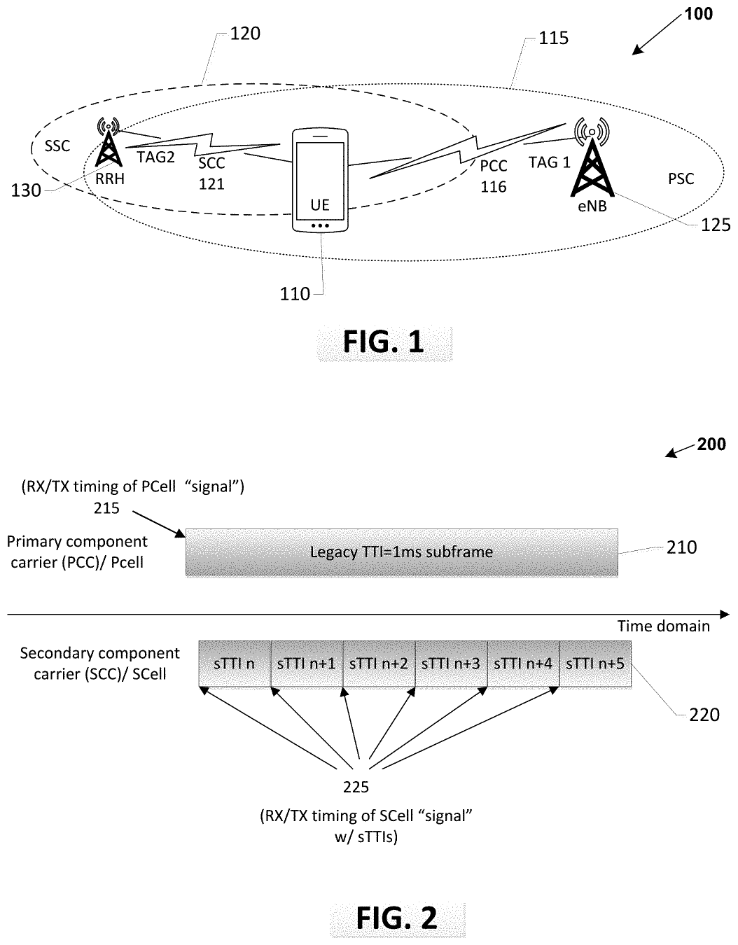

Referring to network diagram 100 of FIG. 1, when carrier aggregation is enabled for LTE-A UE 110, each component carrier represents a serving cell. In a given area, there may be multiple serving cells to which a CA-enabled UE 110 may simultaneously connect using aggregated component carriers: for example, a primary component carrier (PCC) for the primary serving cell (PSC) 115, also referred to herein as a “PCell,” and one or more secondary component carriers (SCC) for one or more secondary serving cells (SSC) 120, also referred to herein an “SCell.” The coverage of serving cells may differ, for example due to CCs on different frequency bands experiencing different fading or path loss and while UE 110 will remain connected to PCell 115 until handover, the UE may change SCCs/SCells 120 as needed or desired without requiring handover.

PCell 115 generally manages UE 110 control information and possibly certain user data via the primary component carrier 116. For example, the UE radio resource control (RRC) connection is only handled by the PCell via the PCC in both DL and UL. On the DL PCC, the UE receives non-access stratum (NAS) information, such as security parameters. In idle mode, the UE listens to system information on the DL PCC, and the physical uplink control channel (PUCCH) from UE 110 is sent on the UL PCC.

UE 110 may be also be connected with one or more SCells 120 via one or more secondary component carriers (SCCs), also referred to as “SCell signals.” The secondary component carrier 121 primarily carries UE data in both UL and DL for SCell 120. An SCell, may either be a different assigned frequency resource from the same eNB as the PCC/PCell, or, as shown in FIG. 1, from another non-collocated network access station 130, such as a remote radio head (RRH), an eNB, an HeNB, a relay node (RN), a next generation new radio network station (a gNB) or other network device. In heterogeneous networks like the example of FIG. 1, CA for UE 110 aggregates primary component carrier 116 between eNB 125 in PCell 115 with secondary component carrier 121 between RRH 130 in SCell 120 to provide higher data rates for UE 110 than w/o CA.

Timing Advance (TA) is a medium access control (MAC) control element (CE) that is used to control uplink signal transmission timing. The network node (e.g., eNodeB 125) facilitating UE over-the-air RF connections with the network, continuously measures the time difference between physical uplink shared channel (PUSCH)/physical uplink control channel (PUCCH)/sounding reference signals (SRS) reception from the UE and subframe timing and can send a “Timing Advance” command to the UE to change the PUSCH/PUCCH transmission to make it better aligned with the subframe timing at the network side. If PUSCH/PUCCH/SRS arrives at the network node 125 too early, network node 125 sends a (TA) command to UE saying “Transmit your signal a little bit late;” If PUSCH/PUCCH/SRS arrives at the network too late, the network sends a TA command to UE saying “Transmit your signal a little bit early.”

The use of multiple timing advances is required for the support of non-collocated cells with Carrier Aggregation. Assuming synchronization to the macro cell's PCell is already obtained, the UE next has to synchronize to the SCell of the other site. In CA, when several carrier components require the same timing advance, these carriers will be grouped in so called timing advance groups (TAG) with the same timing advance. If a TAG contains the PCell, it is referred to as the primary timing advance group (pTAG). If a TAG contains only SCell(s), it is denoted as the secondary timing advance group (sTAG). For pTAG, the PCell is used as the timing reference cell, whereas for sTAG, the UE may use any activated SCell from the same sTAG as the timing reference cell.

The LTE radio frame has a length of 10 ms, and is divided into ten equally sized subframes (n) of 1 ms in length, which consist of 14 OFDM symbols each. Scheduling transmissions is done on a subframe basis for both the downlink and uplink. In FDD mode, each legacy (i.e., R8/R9) subframe consists of two equally sized slots of 0.5 ms in length for maximum number of 20 slots in a frame. Each slot in turn consists of a number of OFDM symbols for data transmission, which can be either seven (normal cyclic prefix) or six (extended cyclic prefix). 3GPP TS 36.211 v.15.0.0 (2017-12), which is fully incorporated herein by its reference, referred to as “Release 15” or R15, LTE further defines the physical layer Type 1 Frame (FDD mode) as a 10 ms radio frame having 10 subframes, 20 slots, or now, additionally, up to 60 subslots are available for scheduling downlink transmissions and the same for uplink transmissions in each 10 ms radio frame.

A transmission time interval (TTI) relates to encapsulation of data from higher layers, i.e., a MAC PDU or segmented MPDU, into subframes for transmission on the radio link layer or physical (PHY) layer. Before R15, the TTI in a 1 ms subframe was LTEs smallest unit of time in which a network access station, e.g., FIG. 1 eNB 125 is capable of scheduling UE 110 for uplink or downlink transmissions. If UE 110 is receiving downlink data, then during each 1 ms subframe, eNB 125 will assign resources and inform user where to look for its downlink data through indexing in the physical downlink control channel (PDCCH) channel. To combat errors due to fading and interference on the radio link, data is divided at the transmitter into transport blocks and then the bits within a block are encoded and interleaved. The length of time required to transmit one such transport block is the TTI. In legacy LTE, the TTI is a 1 ms subframe.

LTE R15, referred to as Gigabit LTE, has provided a new capability for a scalable duration TTI including the ability to schedule a “shortened” or “subslot” transmission time interval (“sTTI”) using between as few as 2 OFDM symbols (i.e., 7 subslots in each 1 ms subframe), up to 7 OFDM symbols to make reception and transmission more efficient with hybrid automatic repeat request (HARQ) error detection and correction.

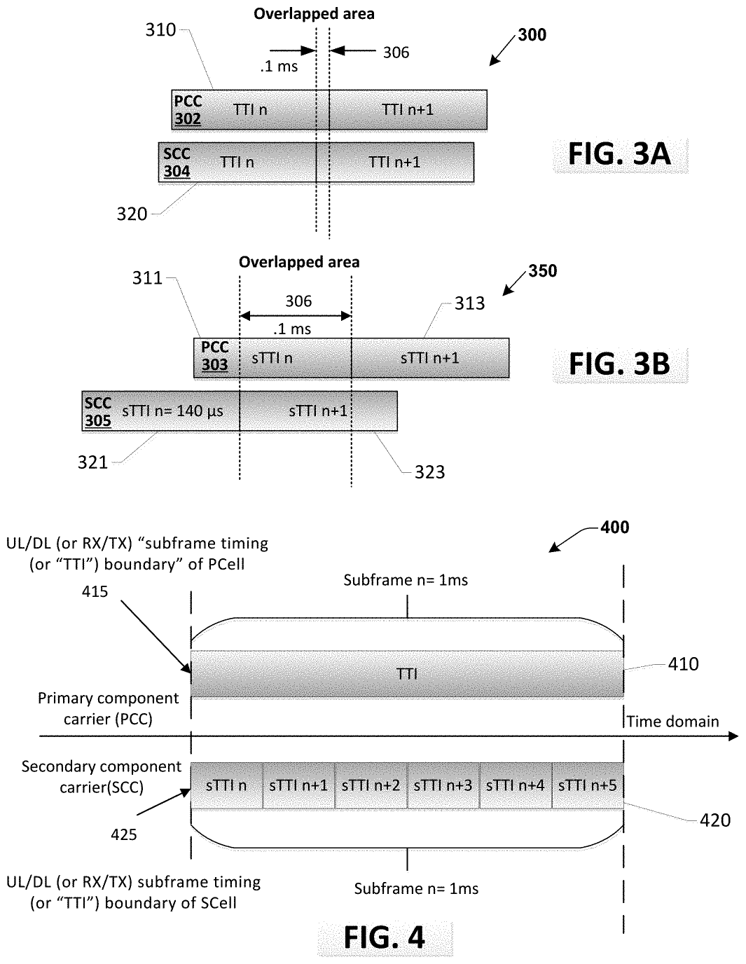

Referring to FIG. 2, a carrier aggregation diagram 200 shows a PCell subframe 210 and an SCell subframe 220 which may be received or transmitted by a UE using LTE-A carrier aggregation. As shown, PCell subframe 210 uses a legacy TTI interval of 1 ms, which is the same duration of the LTE subframe, and SCell subframe 220 is using the sTTI format from R15 in which several sTTIs are available during the same duration of one subframe. Referring to FIGS. 3A and 3B, 3GPP had to implement a requirement for a maximum transmission timing difference (“MTTD”) for PCell and SCell component carriers to address CA using the shortened or subslot TTI of 2 OFDM symbols causing power control and cycling issues for UEs. Since UL/DL transmissions are performed on a TTI, and now sTTI-basis, power control issues arise from CA/sTTI implementation such as a UE exceeding its max transmission power frequently, encountering cyclic closed loop power control back offs, etc. Of course never to be ignored, is the always more desirable constraints on UE battery power. These and other issues required further 3GPP definitions to prevent these and other issues.

FIGS. 3A-3B and respective example diagrams 300 and 350 demonstrate example timing difference issues between legacy TTIs in PCell (PCC) 302 and SCell (SCC) 304 and CA using new sTTI on PCC 303 and SCC signal 305. In FIG. 3A, PCC 302 and SCC 304 both transmit legacy duration TTIs, i.e., having a duration of a 1 ms subframe (12 or 14 OFDM symbols). FIG. 3B shows PCC 303 and SCC 305 signals using the new sTTI in CA component carriers, of for example 2 symbol sTTI which have a time durations of ˜140 μs or (0.14 ms). As can be seen, when carrier components 302 and 304 have a difference of receive timing, shown by overlap 306, the duration of overlap 306 is some fraction of the 1 ms TTIs, say 1/10^{th} or 0.1 ms. However, from FIG. 3B diagram 350, a same receive 0.1 ms timing difference in receiving between PCC 303 and SCC 305 results in transmission interval overlap 307 in which greater than half of the duration of sTTI is overlapped by a same timing difference that wouldn't affect legacy TTI durations, and clearly causes issues.

Accordingly, CA using new sTTI required 3GPP to define a maximum timing difference (MTTD) and maximum receive timing difference (“MRTD”) as “a relative received time difference between the signals received from the PCeLL and SCell at the receiver.” A previous draft of the language is reproduced below, with relevant, but vague italicized as follows:

“7.9 Maximum Transmission Timing Difference in Carrier Aggregation

7.9.1 Introduction:

A UE shall be capable of handling a relative received time difference between the Primary Cell (“PCell”) and Secondary Cell (“SCell”) to be aggregated in inter-band Carrier Aggregation (“CA”) and intra-band non-contiguous CA.

7.9.2 Minimum Requirements for Interband Carrier Aggregation:

The UE shall be capable of handling at least a relative received time difference between the signals received from the PCell and the SCell at the UE receiver of up to 30.26 μs when one SCell is configured.

When two, three, or four SCells are configured, the UE shall be capable of handling at least a relative propagation delay difference between the signals received from any pair of the serving cells (PCell and the SCells) at the UE receiver of up to 30.26 μs.

The UE shall be capable of handling a maximum uplink transmission timing difference between the primary Timing Advance Group (“TAG”) and the sTAG of at least 32.47 μs provided that the UE is:
configured with inter-band CA and
configured with the pTAG and the sTAG,

A UE configured with pTAG and sTAG may stop transmitting on the SCell if after timing adjusting due to received Timing Advance (“TA”) command the uplink transmission timing difference between PCell and SCell exceeds the maximum value the UE can handle as specified above.

The UE shall be capable of handling a maximum uplink transmission timing difference between the pTAG and any of the two sTAGs or between the two sTAGs of at least 32.47 μs provided that the UE is:
configured with inter-band CA and
configured with the two sTAGs,

A UE configured with two sTAGs may stop transmitting on the SCell if after timing adjusting due to received TA command the uplink transmission timing difference between SCell in one sTAG and SCell in other sTAG exceeds the maximum value the UE can handle as specified above.

7.9.3 Minimum Requirements for Intraband Non-Contiguous Carrier Aggregation:

The UE shall be capable of handling at least a relative received time difference between the signals received from the PCell and the SCell at the UE receiver of up to 30.26 μs.

The UE shall be capable of handling a maximum uplink transmission timing difference between the pTAG and the sTAG of at least 32.47 μs provided that the UE is:
configured with intra-band non-contiguous CA and
configured with the pTAG and the sTAG,

A UE configured with pTAG and sTAG may stop transmitting on the SCell if after timing adjusting due to received TA command the uplink transmission timing difference between PCell and SCell exceeds the maximum value the UE can handle as specified above.

7.9.4 Minimum Requirements for Inter-Band Carrier Aggregation Under Frame Structure 3:

The requirements in this section shall apply for Evolved UMTS Terrestrial Radio Access (“E-UTRA”) inter-band carrier aggregation of one Frequency Division Duplex (“FDD”) PCell or one Time Division Duplex (“TDD”) PCell and the SCell(s) following the frame structure type 3.

The UE shall be capable of handling at least a relative received time difference between the signals received from the PCell and the SCell at the UE receiver of up to 30.26 μs when one SCell is configured.

When two or three SCells are configured, the UE shall be capable of handling at least a relative propagation delay difference between the signals received from any pair of the serving cells (PCell and the SCells) at the UE receiver of up to 30.26 μs.”

The MTTD described timing difference requirements UL/DL transmissions were all defined as the received/transmission timing difference between signals on PCell and SCell, which left ambiguous how, or by what reference point, such a small difference may be measured. This in turn made it unclear how a UE chipset may accurately implement algorithms requiring the UE to determine this relative timing difference between signals when different transmission time intervals vary between the PCell and SCell signals. Referring back to FIG. 2, if the PCell uses a legacy LTE TTI of 1 ms subframe 210 the timing of signal on PCell is its TTI boundary 215. However, if the SCell uses the new subslot sTTI format 220, the timing of “signal” 220 of the SCell may be at any point 225 between one sTTI to a another sTTI within a subframe, and. Therefore, in such a case, the UE cannot decide how to determine the relevant timing difference based on this vague definition in prior releases of LTE specifications.

Therefore, a the new receive/transmission timing difference definition is needed enable the timing requirements to be implement in a UE. Various embodiments of the present invention relate to defining UL/DL subframe timing differences of transmitting/receiving serving cell component carriers capable of handling shortened sTTI durations by, for example, referring to FIG. 4, a timing diagram 400 shows the “transmission timing difference” between PCell 410 and SCell 420 “as a relative transmission timing difference between subframe timing boundaries of the PCell and SCell,” An illustrative example 400 of this embodiment definition is shown by subframe lead or initial boundaries 415, 425 for PCell 410 and SCell 420.

Another potential definition is the “transmission timing difference” between PCell 415 and SCell 420 is defined as “the uplink subframe transmission timing difference between PCell and SCell” which corresponds to a difference between PCC and SCC subframe boundaries 415 and 425 (although they are shown aligned in time in diagram 400.) Another literal expression for the “receive timing difference” between PCell 415 and SCell 425 is defined as “a relative receive timing difference between subframe timing boundaries of the PCell and SCell.” Or lastly, an expression of this embodiment is the “receive timing difference” between PCell 415 and SCell 420 is defined or implemented as “a relative receive timing difference between the subframe timing of the signals received from PCell and SCell at the UE receiver.”

In another embodiment of timing difference expression to provide accurate reference point for 3GPP definitions, still referring to diagram 400 of FIG. 4, the “transmission timing difference” between PCell and SCell is defined or implemented as “a relative transmission timing difference between TTI timing boundaries of the PCell and SCell. Here, the term “TTI” will generally include both legacy TTIs (one subframe or 1 ms) and shortened/subslot sTTI (2 symbols or 7 symbols or others).” Once again lead edges of initial TTI 415, sTTI 425 for respective PCell 410 and SCell 415 is equivalent to subframe boundary definitions mentioned previously. Another proposed definition with same meaning is “the transmission timing difference between PCell and SCell is defined or implemented as uplink TTI transmission timing difference between PCell and SCell. Here “TTI” may generally include both legacy TTI (one subframe or 1 ms) and shortened TTI (2 symbols or 7 symbols or others).”

A “receive timing difference” between PCell 410 and SCell 420 can similarly be defined or implemented as “a relative receive timing difference between TTI timing boundaries of the PCell and SCell. Here “TTI” may generally include both legacy TTI (one subframe or 1 ms) and shortened TTI (2 symbols or 7 symbols or others)” or “a relative receive timing difference between the TTI timing of the signals received from PCell and SCell at the UE receiver. Here “TTI” may generally include both legacy TTI (one subframe or 1 ms) and shortened TTI (2 symbols or 7 symbols or others).”

In the foregoing embodiment definitions based on “subframe boundary timing” to determine transmission/receive time differences between UL/DL PCell 410 and SCells 420, even when different TTI durations are used for PCell 410 and SCell 420, the subframe length and structure for PCell and SCell is the same. Accordingly, the transmission/receive timing reference for determining MTTD of PCell 410 and SCell 420 can be considered as the subframe (e.g. they have a same subframe index) boundary timing on PCell or SCell as shown in FIG. 4. The UL/DL (or Rx/Tx) subframe timing boundary of SCell SCC 420 is still the subframe head boundary timing 427, the same reference as the lead boundary generally defined (TTI), including sTTI(n) in subframe 420 SCell.

If different duration transmit time intervals are used for PCell and SCell, the transmission/receive timing on PCell 410 or SCell 420 can be considered as the TTI head boundary timing on PCell or SCell, here the “TTIs” which are used to provide a boundary for determining the timing difference shall be identical or shall have the same time domain index.

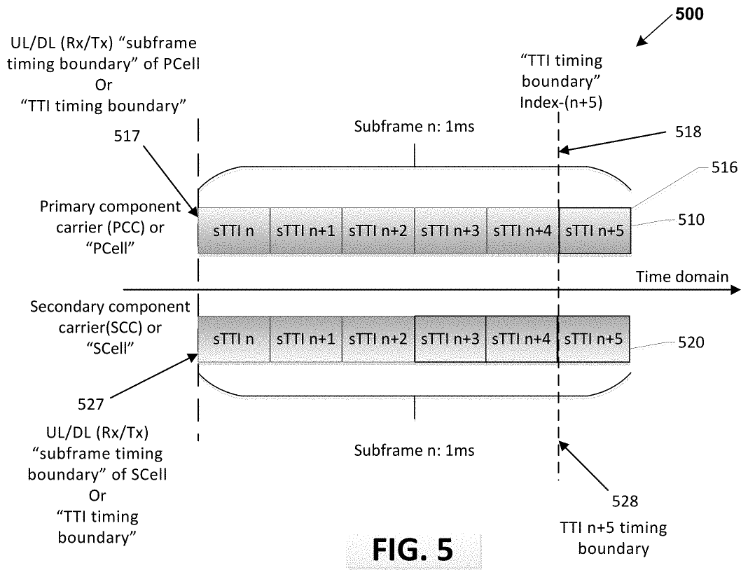

In the case as shown in FIG. 5 timing diagram 500, if the definition is based on “TTI boundary” timing, and both PCell 510 and SCell 520 are using the same duration sTTI, so any sTTI pair (e.g. an sTTI on both PCell and SCell and that have same the same TTI index) may be used to decide the transmission timing difference between PCell 510 and SCell 520. For example, a TTI timing boundaries for PCell 510 and SCell 520 may use TTI boundaries 517, 527 which is pair of sTTI (n) or TTI boundaries 518, 528, which correlates to the sTTI pair indexed by sTTI n+5 on PCell 510 and SCell 520.

It is not trivial decision to select a reference timing definition to calculate MTTD for carrier aggregation using sTTI in subframes because it must be clearly defined to be able to calculate a 30 μs maximum difference between of component carriers, certain of which have resources scheduled at transmit intervals only nearly four times longer of 140 μs. Accordingly, the 1 ms subframe timing boundaries is likely a better solution to the dilemma faced implementing MTTD for CA in LTE.

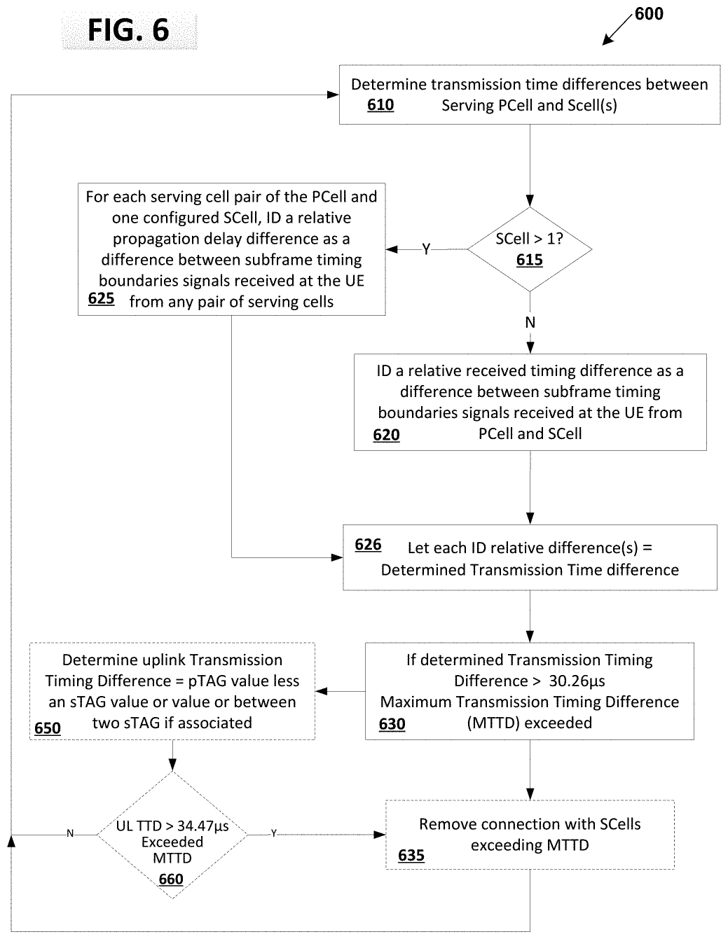

Turning to FIG. 6, a method 600 for user equipment (UE) enabled with carrier aggregation (CA) that may use TTIs of varying durations/shortened or subslot transmission time intervals (sTTI) may generally include determining 605 a Transmission Timing Difference of CA signals received at the UE from a primary serving cell (PCell) and at least on secondary serving cell (SCell).

If 615 only one SCell is configured to serve the UE, a relative received timing difference (RRTD) is identified 620 as a difference between subframe timing boundaries signals PCell and the configured SCell received at the UE; else

Then 615 two or more SCells are configured to serve the UE, for each serving cell pair of the PCell and one configured SCell, a relative propagation delay difference is identified 625 as a difference between subframe timing boundaries signals received at the UE from any pair of serving cells.

Either of the identified relative differences (e.g., propagation delay or received timing is 628) for each determination is a determined Transmission Timing Difference and is compared 630 to the threshold time value, presently 30.26 μs, for determining that the maximum transmission timing difference (MTTD) is exceeded or not. Optionally, method 630 may further proceed to disconnect serving secondary cells for which the MTTD was exceeded and the steps will be periodically repeated to ensure compliance with the MTTD for CA aggregation involving variable length TTIs.

Method 600 may also, optionally, make determination and compliance with MTTD for uplink transmissions from the UE if desired. In this case, the UE can simplify the procedure because the eNB or other network access station facilitating the PCell and SCell(s) already manage UE uplink transmission timings and can instruct the UE to offset its uplink transmissions via timing advance (TA) commands, as described earlier commands. When a UE is attached to a PCell and SCell using inter-band or non-contiguous intra-band CA, the UE may be associated in groups with other UEs and receive pTAG and sTAG timing information to adjust its own uplink transmission timing on the related component carrier. The PCell and SCell(s) serving the UE will provide TAG values to the UE. Thus the UE can already provide pTAG and sTAG values to determine if the uplink MTTD is exceeded. For example, method 600 may determine 650 whether the UL maximum transmission timing difference (MTTD) for CA is exceeded simply by comparing 660 the difference between serving cell pTAG and sTAG values, or if applicable, between 2 sTAG values, with an uplink transmission timing threshold. Presently, the uplink maximum transmission timing difference threshold time value is 32.47 μs.

If 660 it is exceeded, the UE may disconnect 635 with the out of range SCell or if not, simply return to checking the downlink transmission timing differences. Of course they can be done simultaneously and the flow diagram of FIG. 6 is only for understanding principles of operation of the inventive embodiments.

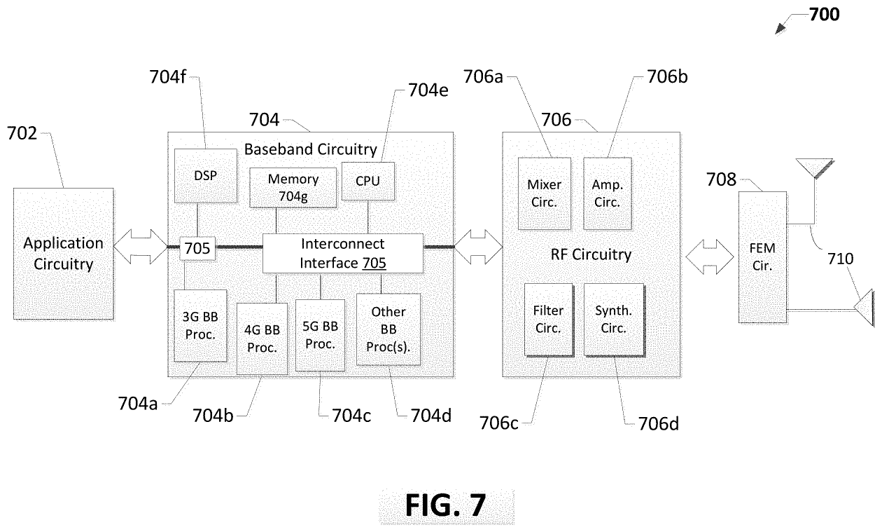

Referring to FIG. 7, a wireless communication device 700 configured to use carrier aggregation and determining timing differences between a PCell and SCells will now be described. As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

Embodiments described herein may be implemented into a system using any suitably configured hardware and/or software. FIG. 7 illustrates, for one embodiment, example components of an electronic device 700. In embodiments, the electronic device 700 may be, implement, be incorporated into, or otherwise be a part of a user equipment (UE). In some embodiments, the electronic device 700 may include application circuitry 702, baseband circuitry 704, Radio Frequency (RF) circuitry 706, front-end module (FEM) circuitry 708 and one or more antennas 710, coupled together at least as shown. Electronic device 700 may include interconnects (shown by arrows and dark lines) such as PCIe, Advanced eXtensible Interconnect (AXI) or open core protocol (OCP) or the like to exchange information and/or signals between a host, various peripherals or sub-peripherals, referred to as components. And each component using the interconnect, must have an interface 705 to do so.

The application circuitry 702 may include one or more application processors or processing units. For example, the application circuitry 702 may include circuitry such as, but not limited to, one or more single-core or multi-core processors 702a. The processor(s) 702a may include any combination of general-purpose processors and dedicated processors (e.g., graphics processors, application processors, etc.). The processors 702a may be coupled with and/or may include computer-readable media 702b (also referred to as “CRM 702b”, “memory 702b”, “storage 702b”, or “memory/storage 702b”) and may be configured to execute instructions stored in the CRM 702b to enable various applications and/or operating systems to run on the system and/or enable features of the inventive embodiments to be enabled.

The baseband circuitry 704 may include circuitry such as, but not limited to, one or more single-core or multi-core processors to arrange, configure, process, generate, transmit, receive, or otherwise determine time differences of carrier aggregation signals as described in various embodiments herein. The baseband circuitry 704 may include one or more baseband processors and/or control logic to process baseband signals received from a receive signal path of the RF circuitry 706 via an interconnect interface 705 and to generate baseband signals for a transmit signal path of the RF circuitry 706. Baseband circuitry 704 may also interface 705 via an interconnect, with the application circuitry 702 for generation and processing of the baseband signals and for controlling operations of the RF circuitry 706. For example, in some embodiments, the baseband circuitry 704 may include a third generation (3G) baseband processor 704a, a fourth generation (4G) baseband processor 704b, a fifth generation (5G)/NR baseband processor 704c, and/or other baseband processor(s) 704d for other existing generations, generations in development or to be developed in the future (e.g., 6G, etc.). The baseband processing circuit 704 (e.g., one or more of baseband processors 704a-d) may handle various radio control functions that enable communication with one or more radio networks via the RF circuitry 706. The radio control functions may include, but are not limited to, signal modulation/demodulation, encoding/decoding, radio frequency shifting, as well as measuring time difference between carrier aggregation signals as discussed previously. In some embodiments, modulation/demodulation circuitry of the baseband circuitry 704 may include Fast-Fourier Transform (FFT), precoding, and/or constellation mapping/demapping functionality. In some embodiments, encoding/decoding circuitry of the baseband circuitry 704 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 704 may include elements of a protocol stack such as, for example, elements of an evolved universal terrestrial radio access network (E-UTRAN) protocol including, for example, physical (PHY), media access control (MAC), radio link control (RLC), packet data convergence protocol (PDCP), and/or radio resource control (RRC) elements. A central processing unit (CPU) 704e of the baseband circuitry 704 may be configured to run elements of the protocol stack for signaling of the PHY, MAC, RLC, PDCP and/or RRC layers. In some embodiments, the baseband circuitry may include one or more digital signal processor(s) (DSP) 704f for audio processing. The DSP(s) 704f may include elements for compression/decompression and echo cancellation and may include other suitable processing elements in other embodiments. The baseband circuitry 704 may further include computer-readable media 704g (also referred to as “CRM 704g”, “memory 704g”, or “storage 704g”). The CRM 704g may be used to load and store data and/or instructions for operations performed by the processors of the baseband circuitry 704. CRM 704g for one embodiment may include any combination of suitable volatile memory and/or non-volatile memory. The CRM 704g may include any combination of various levels of memory/storage including, but not limited to, read-only memory (ROM) having embedded software instructions (e.g., firmware), random access memory (e.g., dynamic random access memory (DRAM)), cache, buffers, etc.). The CRM 704g may be shared among the various processors or dedicated to particular processors. Components of the baseband circuitry 704 may be suitably combined in a single chip, a single chipset, or disposed on a same circuit board in some embodiments. In some embodiments, some or all of the constituent components of the baseband circuitry 704 and the application circuitry 702 may be implemented together, such as, for example, on a system on a chip (SOC).

In some embodiments, the baseband circuitry 704 may provide for communication compatible with one or more radio technologies. For example, in some embodiments, the baseband circuitry 704 may support communication with an E-UTRAN, NR and/or other wireless metropolitan area networks (WMAN), a wireless local area network (WLAN), a wireless personal area network (WPAN). Embodiments in which the baseband circuitry 704 is configured to support radio communications of more than one wireless protocol may be referred to as multi-mode baseband circuitry.

RF circuitry 706 may enable communication with wireless networks using modulated electromagnetic radiation through a non-solid medium. In various embodiments, the RF circuitry 706 may include switches, filters, amplifiers, etc., to facilitate the communication with the wireless network. RF circuitry 706 may include a receive signal path that may include circuitry to down-convert RF signals received from the FEM circuitry 708 and provide baseband signals to the baseband circuitry 104. RF circuitry 706 may also include a transmit signal path that may include circuitry to up-convert baseband signals provided by the baseband circuitry 704 and provide RF output signals to the FEM circuitry 708 for transmission.

In some embodiments, the RF circuitry 706 may include a receive signal path and a transmit signal path. The receive signal path of the RF circuitry 706 may include mixer circuitry 706a, amplifier circuitry 706b and filter circuitry 706c. The transmit signal path of the RF circuitry 706 may include filter circuitry 706c and mixer circuitry 706a. RF circuitry 706 may also include synthesizer circuitry 706d for synthesizing a frequency for use by the mixer circuitry 706a of the receive signal path and the transmit signal path. In some embodiments, the mixer circuitry 706a of the receive signal path may be configured to down-convert RF signals received from the FEM circuitry 708 based on the synthesized frequency provided by synthesizer circuitry 706d. The amplifier circuitry 706b may be configured to amplify the down-converted signals and the filter circuitry 706c may be a low-pass filter (LPF) or band-pass filter (BPF) configured to remove unwanted signals from the down-converted signals to generate output baseband signals. Output baseband signals may be provided to the baseband circuitry 704 for further processing. In some embodiments, the output baseband signals may be zero-frequency baseband signals, although this is not a requirement. In some embodiments, mixer circuitry 706a of the receive signal path may comprise passive mixers, although the scope of the embodiments is not limited in this respect.

In some embodiments, the mixer circuitry 706a of the transmit signal path may be configured to up-convert input baseband signals via interconnect and based on the synthesized frequency provided by the synthesizer circuitry 706d to generate RF output signals for the FEM circuitry 708. The baseband signals may be provided by the baseband circuitry 704 and may be filtered by filter circuitry 706c. The filter circuitry 706c may include a low-pass filter (LPF), although the scope of the embodiments is not limited in this respect.

In some embodiments, the mixer circuitry 706a of the receive signal path and the mixer circuitry 706a of the transmit signal path may include two or more mixers and may be arranged for quadrature downconversion and/or upconversion, respectively. In some embodiments, the mixer circuitry 706a of the receive signal path and the mixer circuitry 706a of the transmit signal path may include two or more mixers and may be arranged for image rejection (e.g., Hartley image rejection). In some embodiments, the mixer circuitry 706a of the receive signal path and the mixer circuitry 706a of the transmit signal path may be arranged for direct downconversion and/or direct upconversion, respectively. In some embodiments, the mixer circuitry 706a of the receive signal path and the mixer circuitry 706a of the transmit signal path may be configured for super-heterodyne operation.

In some embodiments, the output baseband signals and the input baseband signals may be analog baseband signals which are digitally converted to provide digital data to processors via interface 705 to through the interconnect, although the scope of the embodiments is not limited in this respect. In some alternate embodiments, the output baseband signals and the input baseband signals may be digital baseband signals. In these alternate embodiments, the RF circuitry 706 may include analog-to-digital converter (ADC) and digital-to-analog converter (DAC) circuitry and the baseband circuitry 704 may include an RF interface 705, such as an analog or digital baseband interface, to communicate with the RF circuitry 706.

In dual-mode embodiments, a separate radio IC circuitry may be provided for processing signals for each spectrum, although the scope of the embodiments is not limited in this respect.

In some embodiments, the synthesizer circuitry 706d may be a fractional-N synthesizer or a fractional N/N+1 synthesizer, although the scope of the embodiments is not limited in this respect, as other types of frequency synthesizers may be suitable. For example, synthesizer circuitry 706d may be a delta-sigma synthesizer, a frequency multiplier, or a synthesizer comprising a phase-locked loop with a frequency divider. The synthesizer circuitry 706d may be configured to synthesize an output frequency for use by the mixer circuitry 706a of the RF circuitry 706 based on a frequency input and a divider control input. In some embodiments, the synthesizer circuitry 706d may be a fractional N/N+1 synthesizer.

In some embodiments, frequency input may be provided by a voltage controlled oscillator (VCO), although that is not a requirement. Divider control input may be provided by either the baseband circuitry 704 or the application circuitry 702 depending on the desired output frequency. In some embodiments, a divider control input (e.g., N) may be determined from a look-up table based on a channel indicated by the application circuitry 702.

Synthesizer circuitry 706d of the RF circuitry 706 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 706d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 706 may include an IQ/polar converter.

FEM circuitry 708 may include a receive signal path that may include circuitry configured to operate on RF signals received from one or more antennas 710, amplify the received signals and provide the amplified versions of the received signals to the RF circuitry 706 for further processing. FEM circuitry 708 may also include a transmit signal path that may include circuitry configured to amplify signals for transmission provided by the RF circuitry 706 for transmission by one or more of the one or more antennas 710. In some embodiments, the FEM circuitry 708 may include a TX/RX switch to switch between transmit mode and receive mode operation. The FEM circuitry 708 may include a receive signal path and a transmit signal path. The receive signal path of the FEM circuitry may include a low-noise amplifier (LNA) to amplify received RF signals and provide the amplified received RF signals as an output (e.g., to the RF circuitry 706). The transmit signal path of the FEM circuitry 708 may include a power amplifier (PA) to amplify input RF signals (e.g., provided by RF circuitry 706), and one or more filters to generate RF signals for subsequent transmission (e.g., by one or more of the one or more antennas 710).

In some embodiments, the electronic device 700 may include additional elements such as, for example, a display, a camera, one or more sensors, and/or interface 705 to interconnect (for example, input/output (I/O) interfaces or buses). In embodiments where the electronic device is implemented to provide networking functions, the electronic device 700 may include network interface circuitry. The network interface circuitry may be one or more computer hardware components that connect electronic device 700 to one or more network elements, such as one or more servers within a core network via one or more wired connections. To this end, the network interface circuitry may include one or more dedicated processors and/or field programmable gate arrays (FPGAs) to communicate using one or more network communications protocols such as X2 application protocol (AP), S1 AP, Stream Control Transmission Protocol (SCTP), Ethernet, Point-to-Point (PPP), Fiber Distributed Data Interface (FDDI), and/or any other suitable network communications protocols.

As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.” “Interface” may simply be a connector or bus wire through which signals are transferred, including one or more pins on an integrated circuit.

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.”

### EXAMPLE EMBODIMENTS

According to a First Example embodiment, an apparatus is disclosed for a user equipment (UE) communication device to communicate in a wireless network capable of carrier aggregation (CA), the apparatus including a baseband processing circuit including one or more processors configured to determine whether a timing difference between uplink or downlink CA signals between the UE and a primary serving cell (PCell) and at least one secondary serving cell (SCell) exceeds a maximum transmission timing difference (MTTD) by: for downlink (DL) CA signals received at the UE: identifying a relative received timing difference as a difference between subframe timing boundaries of signals from the PCell and SCell at the UE receiver when one SCell is serving the UE; or identifying a relative propagation delay difference as a difference between subframe timing boundaries of signals received from any pair of serving cells (PCell and the SCells) at the UE receiver when more than one SCell is serving the UE; and comparing the relative received timing difference or the relative propagation delay difference to a downlink maximum transmission timing difference (dMTTD) threshold value. The apparatus further includes an interconnect interface coupled to the baseband processing unit and adapted to enable the one or more processors to communicate signals between at least one UE component selected from a group comprising: a dual band radio frequency (RF) transceiver, a memory circuit, an application processor or a digital signal processor (DSP), via an interconnect bus.

In a Second Example embodiment, the First Example is further defined wherein the baseband processing circuit is further figured to determine whether the timing difference between uplink or downlink CA signals exceeds the maximum transmission timing difference by: for uplink (UL) CA signals transmitted by the UE: determining whether an uplink transmission timing difference between a PCell timing advance group (pTAG) value and an SCell timing advance group (sTAG) value or between two sTAG values exceeds an uplink maximum transmission timing difference (uMTTD) threshold value.

A Third Example embodiment may further define any of the prior Examples wherein the dMTTD threshold value is 30.26 μs and the uMTTD threshold value is 32.47 μs.

A Fourth Example embodiment may further any of the prior Example embodiments by the baseband processing circuit further configured to stop transmitting or receiving data with one or more SCells determined to exceed the maximum transmission timing difference.

In a Fifth Example embodiment, any of the First through Fourth Examples may be further defined wherein the baseband processing circuit is configured to use at least one of inter-band or non-contiguous intra-band CA.

According to a Sixth Example embodiment, any of the prior examples may include the baseband processing circuit is further configured for determining the relative received timing difference, additionally in alternative, as a difference between timing boundaries of: (i) a first or last subslot transmission timing interval (sTTI) used by one serving cell and a corresponding subframe boundary of another serving cell using a different duration TTI, or by corresponding boundaries of commonly indexed sTTIs used by both serving cells.

In a Seventh Example embodiment, any of the prior embodiments may also include the component carriers for the PCell at lease one SCell schedule UL and DL transmissions of medium access protocol data units (MPDU) or segmented MPDUs and control information in a radio resource comprising a plurality of 10 ms long radio frame divided into 1 ms subframes using variable sized transmission time intervals (TTIs) ranging between 2 to 14 orthogonal frequency division multiplexing (OFDM) symbols.

In an Eighth Example and any of the First through Seventh Examples may be further defined by the relative timing difference being used, at least partially, to prevent the UE from exceeding maximum transmit power due to misaligned transmit time intervals of aggregated PCell and SCell component carriers.

According to a Ninth Example further any of the prior examples by the PCell and the at least one SCell utilize component carriers having different frequency resources from a same network access station.

A Tenth Example embodiment may include any of the First through Ninth Examples by the PCell and the at least one SCell utilize component carriers having different frequency resources from two non-collocated network access stations.

According to an Eleventh Example embodiment, a method is disclosed for a user equipment (UE) to determine a maximum transmission timing difference (MTTD) in Carrier Aggregation (CA) signals between a primary serving cell (PCell) and at least one secondary serving cell (SCell), the method including: when only one SCell is configured to serve the UE-identifying a relative received timing difference between subframe timing boundaries of PCell and SCell signals received at the UE; and comparing the identified relative receive timing difference with a threshold time value. When two or more SCells are configured to serve the UE—for each configured SCell and the PCell, as a pair, identifying a relative propagation delay difference as a difference between subframe timing boundaries of signals received at the UE from any PCell and SCell pair. Lastly, comparing the identified relative propagation delay difference with the threshold time value.

A Twelfth Example may add to any of the prior examples by setting the threshold time value to 30.26 μs.

Any of the prior examples may be furthered by an Thirteenth Example where the UE uses at least one of inter-band or non-contiguous intra-band carrier aggregation.

In a Fourteenth Example embodiment, the Eleventh through Thirteenth Examples may be improved by using, alternatively to the subframe timing difference, the relative received timing difference is identified based on a time boundary of a subslot transmission timing interval (sTTI) used in at least one of the PCell and SCell signals.

In a Fifteenth Example embodiment, any of the prior examples may define further, the PCell and SCell signals schedule UL and DL transmissions for data and control information in a radio resource comprising a 10 ms long radio frame divided into 1 ms subframes using variable sized transmission time intervals (TTIs) ranging between 2 to 14 orthogonal frequency division multiplexing (OFDM) symbols per subframe.

According to a Sixteenth Example embodiment, any of the prior examples may be furthered wherein the relative received timing difference is used, at least partially, to prevent the UE from exceeding maximum transmit power due to misaligned transmit time intervals of the PCell and SCell signals.

The Seventeenth Example may further any of the prior examples wherein the PCell and SCell signals comprise different frequency resources from a same wireless network access station.

In an Eighteenth Example any one of the prior examples may include stopping transmissions with one or more SCells if the threshold value is exceeded after comparing the identified relative propagation delay or the relative time difference.

A Nineteenth Example embodiment relates to a computer-readable medium storing executable instructions that, in response to execution, cause one or more processors of a baseband processing circuit of a user equipment (UE) enabled with carrier aggregation (CA), to perform operations including: (1) determining a transmission timing difference of CA signals received at the UE from a primary serving cell (PCell) and at least one secondary serving cell (SCell) by (a) when only a single SCell is configured to serve the UE, identifying a relative received timing difference as a difference between subframe timing boundaries signals received at the UE from the PCell and the configured SCell; or (b) when two or more SCells are configured to serve the UE, for each serving cell pair of the PCell and one configured SCell, identifying a relative propagation delay difference as a difference between subframe timing boundaries signals received at the UE from any pair of serving cells; and (2) identifying a maximum transmission timing difference is exceeded if said determined transmission timing difference exceeds a threshold time value.

A Twentieth Example embodiment may further define any prior example by the CRM performing an operation to (3) determine whether the timing difference between uplink signals exceed the maximum transmission timing difference for uplink (UL) signals transmitted by the UE by: determining whether an uplink transmission timing difference between a PCell timing advance group (pTAG) value and an SCell timing advance group (sTAG) value or between two sTAG values exceeds a maximum uplink transmission timing difference threshold value.

According to a Twenty-First Example embodiment, the prior three examples are furthered when the maximum downlink threshold timing value is 30.26 μs and the maximum uplink transmission timing difference threshold time value is 32.47 μs.

In a Twenty-Second Example embodiment, the Nineteenth through Twenty-First Examples include the computer-readable medium storing executable instructions, when executed, further cause the baseband processing circuit to perform operations comprising: (4) stopping transmitting or receiving data with one or more SCells determined to exceed the maximum transmission timing difference.

A Twenty-Third Example may include any of the prior example embodiments such that the carrier aggregation comprises one of inter-band or non-contiguous intra-band carrier aggregation.

A Twenty-Fourth Example defines an apparatus for use in a user equipment (UE) communication device to communicate in a wireless network capable of carrier aggregation (CA), the apparatus including a processing means for determining whether a timing difference between uplink or downlink CA signals between the UE and a primary serving cell (PCell) and at least one secondary serving cell (SCell) exceeds a maximum transmission timing difference (MTTD) by: —for downlink (DL) CA signals received at the UE, identifying a relative received timing difference as a difference between subframe timing boundaries of signals from the PCell and SCell at the UE receiver when one SCell is serving the UE; or identifying a relative propagation delay difference as a difference between subframe timing boundaries of signals received from any pair of serving cells (PCell and the SCells) at the UE receiver when more than one SCell is serving the UE; and comparing the relative received timing difference or the relative propagation delay difference to a downlink maximum transmission timing difference (dMTTD) threshold value.

According to a Twenty-Fifth Example embodiment, a wireless device may include any element or perform any function as in the prior example embodiments and causes a user equipment (UE) to determine a maximum transmission timing difference (MTTD) in Carrier Aggregation (CA) signals between a primary serving cell (PCell) and at least one secondary serving cell (SCell), the device comprising: when only one SCell is configured to serve the UE, means for identifying a relative received timing difference between subframe timing boundaries of PCell and SCell signals received at the UE; and means for comparing the identified relative receive timing difference with a threshold time value or, when two or more SCells are configured to serve the UE—means for identifying, for each configured SCell and the PCell, as a pair, a relative propagation delay difference as a difference between subframe timing boundaries of signals received at the UE from any PCell and SCell pair and means for comparing the identified relative propagation delay difference with the threshold time value.

A Twenty-Sixth Example embodiment may defines a mobile unit including means for determining a transmission timing difference of CA signals received at a UE from a primary serving cell (PCell) and at least one secondary serving cell (SCell) by identifying a relative received timing difference as a difference between subframe timing boundaries signals received at the UE from the PCell and the configured SCell, when only a one SCell is configured to serve the UE, or for each serving cell pair of the PCell and one configured SCell, identifying a relative propagation delay difference as a difference between subframe timing boundaries signals received at the UE from any pair of serving cells, when two or more SCells are configured to serve the UE. Mobile unit may further include means for identifying a maximum transmission timing difference is exceeded if said determined transmission timing difference exceeds a threshold time value.

A Twenty-Seventh Example embodiment defines an apparatus for a UE having means for executing each of the steps in the Eleventh through Eighteenth example embodiments.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The present disclosure has been described with reference to the attached drawing figures, with certain example terms and wherein like reference numerals are used to refer to like elements throughout. The illustrated structures, devices and methods are not intended to be drawn to scale, or as any specific circuit or any in any way other than as functional block diagrams to illustrate certain features, advantages and enabling disclosure of the inventive embodiments and their illustration and description is not intended to be limiting in any manner in respect to the appended claims that follow, with the exception of 35 USC 112, sixth paragraph, claims using the literal words “means for,” if present in a claim. As utilized herein, the terms “component,” “system,” “interface,” “logic,” “circuit,” “device,” and the like are intended only to refer to a basic functional entity such as hardware, processor designs, software (e.g., in execution), logic (circuits or programmable), firmware alone or in combination to suit the claimed functionalities. For example, a component, module, circuit, device or processing unit “configured to,” “adapted to” or “arranged to” may mean a microprocessor, a controller, a programmable logic array and/or a circuit coupled thereto or other logic processing device, and a method or process may mean instructions running on a processor, firmware programmed in a controller, an object, an executable, a program, a storage device including instructions to be executed, a computer, a tablet PC and/or a mobile phone with a processing device. By way of illustration, a process, logic, method or module can be any analog circuit, digital processing circuit or combination thereof. One or more circuits or modules can reside within a process, and a module can be localized as a physical circuit, a programmable array, a processor. Furthermore, elements, circuits, components, modules and processes/methods may be hardware or software, combined with a processor, executable from various computer readable storage media having executable instructions and/or data stored thereon. Those of ordinary skill in the art will recognize various ways to implement the logical descriptions of the appended claims and their interpretation should not be limited to any example or enabling description, depiction or layout described above, in the abstract or in the drawing figures.

1-24. (canceled)

26. An apparatus for a user equipment (UE) communication device to communicate in a wireless network capable of carrier aggregation (CA), the apparatus comprising:
a baseband processing circuit including one or more processors configured to determine whether a timing difference between uplink or downlink CA signals between the UE and a primary serving cell (PCell) and at least one secondary serving cell (SCell) exceeds a maximum transmission timing difference (MTTD) by:
for downlink (DL) CA signals received at the UE:
identifying a relative received timing difference as a difference between subframe timing boundaries of signals from the PCell and SCell at the UE receiver when one SCell is serving the UE; or
identifying a relative propagation delay difference as a difference between subframe timing boundaries of signals received from any pair of serving cells (PCell and the SCells) at the UE receiver when more than one SCell is serving the UE; and
comparing the relative received timing difference or the relative propagation delay difference to a downlink maximum transmission timing difference (dMTTD) threshold value; and
an interconnect interface coupled to the baseband processing unit and adapted to enable the one or more processors to communicate signals between at least one UE component selected from a group comprising: a dual band radio frequency (RF) transceiver, a memory circuit, an application processor or a digital signal processor (DSP), via an interconnect bus.

27. The apparatus of claim 26, wherein the baseband processing circuit is further figured to determine whether the timing difference between uplink or downlink CA signals exceeds the maximum transmission timing difference by:
for uplink (UL) CA signals transmitted by the UE:
determining whether an uplink transmission timing difference between a PCell timing advance group (pTAG) value and an SCell timing advance group (sTAG) value or between two sTAG values exceeds an uplink maximum transmission timing difference (uMTTD) threshold value.

28. The apparatus of claim 27 wherein the dMTTD threshold value is 30.26 μs and the uMTTD threshold value is 32.47 μs.

29. The apparatus of claim 26 wherein the baseband processing circuit is further configured to:
stop transmitting or receiving data with one or more SCells determined to exceed the maximum transmission timing difference.

30. The apparatus of claim 26 wherein the baseband processing circuit is configured to use at least one of inter-band or non-contiguous intra-band CA.

31. The apparatus of claim 26 wherein the baseband processing circuit is further configured to determine the relative received timing difference, additionally in alternative, as a difference between timing boundaries of: (i) a first or last subslot transmission timing interval (sTTI) used by one serving cell and a corresponding subframe boundary of another serving cell using a different duration TTI, or by corresponding boundaries of commonly indexed sTTIs used by both serving cells.

32. The apparatus of claim 26 wherein the component carriers for the PCell at lease one SCell schedule UL and DL transmissions of medium access protocol data units (MPDU) or segmented MPDUs and control information in a radio resource comprising a plurality of 10 ms long radio frame divided into 1 ms subframes using variable sized transmission time intervals (TTIs) ranging between 2 to 14 orthogonal frequency division multiplexing (OFDM) symbols.

33. The apparatus of claim 26 wherein the relative timing difference is used, at least partially, to prevent the UE from exceeding maximum transmit power due to misaligned transmit time intervals of aggregated PCell and SCell component carriers.

34. The apparatus of claim 26 wherein the PCell and the at least one SCell utilize component carriers having different frequency resources from a same network access station.

35. The apparatus of claim 26 wherein the PCell and the at least one SCell utilize component carriers having different frequency resources from two non-collocated network access stations.

36. A method for a user equipment (UE) to determine a maximum transmission timing difference (MTTD) in Carrier Aggregation (CA) signals between a primary serving cell (PCell) and at least one secondary serving cell (SCell), the method comprising:
when only one SCell is configured to serve the UE:
identifying a relative received timing difference between subframe timing boundaries of PCell and SCell signals received at the UE; and
comparing the identified relative receive timing difference with a threshold time value; or
when two or more SCells are configured to serve the UE:
for each configured SCell and the PCell, as a pair, identifying a relative propagation delay difference as a difference between subframe timing boundaries of signals received at the UE from any PCell and SCell pair; and
comparing the identified relative propagation delay difference with the threshold time value.

37. The method of claim 36 wherein the threshold time value is 30.26 μs.

38. The method of claim 36 wherein the UE uses at least one of inter-band or non-contiguous intra-band carrier aggregation.

39. The method of claim 36 wherein alternatively to the subframe timing difference, the relative received timing difference is identified based on a time boundary of a subslot transmission timing interval (sTTI) used in at least one of the PCell and SCell signals.

40. The method of claim 36 wherein the PCell and SCell signals schedule UL and DL transmissions for data and control information in a radio resource comprising a 10 ms long radio frame divided into 1 ms subframes using variable sized transmission time intervals (TTIs) ranging between 2 to 14 orthogonal frequency division multiplexing (OFDM) symbols per subframe.

41. The method of claim 36 wherein the relative received timing difference is used, at least partially, to prevent the UE from exceeding maximum transmit power due to misaligned transmit time intervals of the PCell and SCell signals.

42. The method of claim 36 wherein the PCell and SCell signals comprise different frequency resources from a same wireless network access station.

43. The method of claim 36 further comprising:
stopping transmissions with one or more SCells if the threshold value is exceeded after comparing the identified relative propagation delay or the relative time difference.

44. A computer-readable medium storing executable instructions that, in response to execution, cause one or more processors of a baseband processing circuit of a user equipment (UE) enabled with carrier aggregation (CA), to perform operations comprising:
(1) determining a transmission timing difference of CA signals received at the UE from a primary serving cell (PCell) and at least one secondary serving cell (SCell) by,
(a) when only a single SCell is configured to serve the UE, identifying a relative received timing difference as a difference between subframe timing boundaries signals received at the UE from the PCell and the configured SCell; or
(b) when two or more SCells are configured to serve the UE, for each serving cell pair of the PCell and one configured SCell, identifying a relative propagation delay difference as a difference between subframe timing boundaries signals received at the UE from any pair of serving cells; and
(2) identifying a maximum transmission timing difference is exceeded if said determined transmission timing difference exceeds a threshold time value.

45. The computer-readable medium of claim 44 storing executable instructions, that when executed, further cause the baseband processing circuit to perform operations comprising:
(3) determine whether the timing difference between uplink signals exceed the maximum transmission timing difference for uplink (UL) signals transmitted by the UE by:
determining whether an uplink transmission timing difference between a PCell timing advance group (pTAG) value and an SCell timing advance group (sTAG) value or between two sTAG values exceeds a maximum uplink transmission timing difference threshold value.

46. The computer-readable medium of claim 45 wherein the maximum downlink threshold timing value is 30.26 μs and the maximum uplink transmission timing difference threshold time value is 32.47 μs.

47. The computer-readable medium of claim 44 storing executable instructions, that when executed, further cause the baseband processing circuit to perform operations comprising:
(4) stopping transmitting or receiving data with one or more SCells determined to exceed the maximum transmission timing difference.

48. The computer readable medium of claim 44, wherein the carrier aggregation comprises one of inter-band or non-contiguous intra-band carrier aggregation.
